(19) United States
(12) Patent Application Publication
(10) Pub. No.: US 2016/0027036 A1
(43) Pub. Date: Jan. 28, 2016

(54) PROVIDING PREDICTIVE ANALYSIS FOR WEBSITE MARKETERS

(71) Applicants: Ian Lurie, Seattle, WA (US); Steven Allen Gahler, Seattle, WA (US)

(72) Inventors: Ian Lurie, Seattle, WA (US); Steven Allen Gahler, Seattle, WA (US)

(21) Appl. No.: 14/671,874

(22) Filed: Mar. 27, 2015

Related U.S. Application Data
(60) Provisional application No. 61/971,159, filed on Mar. 27, 2014.

(51) Int. Cl. G06Q 30/02

(52) U.S. Cl. CPC G06Q 30/0242

(57) ABSTRACT

A method comprising the step of analyzing a website and generating a performance grade of said website.

### PRIORITY CLAIM

The present application claims the benefit of priority to and incorporates by reference in its entirety U.S. Prov. Appl. No. 61/971,159 filed Mar. 27, 2014.

### BRIEF DESCRIPTION OF THE DRAWINGS

FIGS. 1-4 are schematic illustrations of one or more embodiments of the invention and/or environments in which one or more embodiments of the invention may be implemented.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

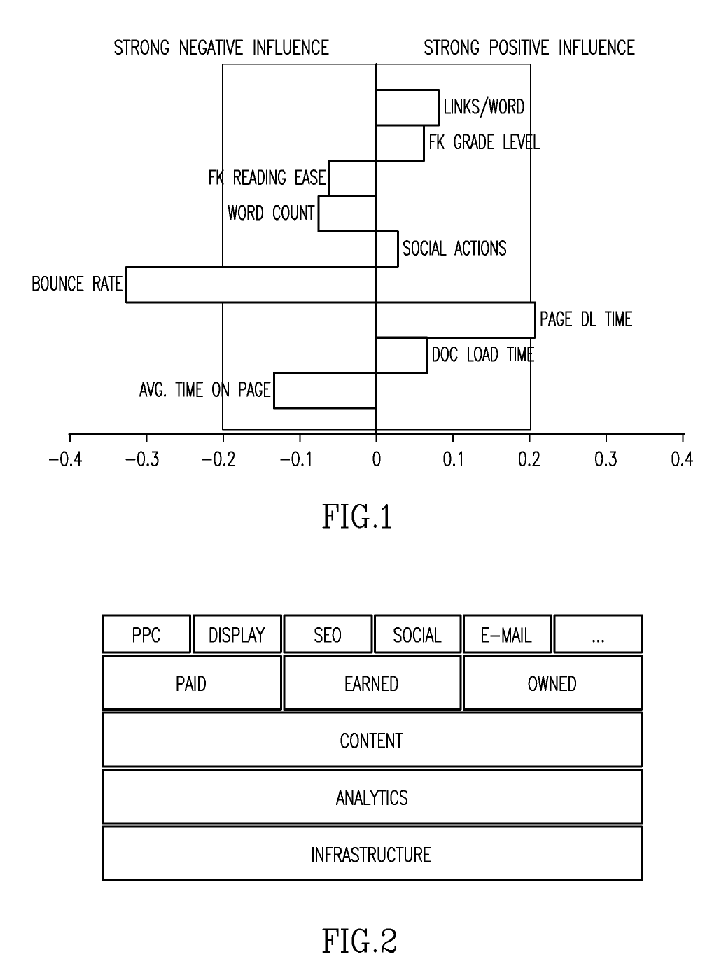

FIG. 1 illustrates an example of a computing system environment 100 in which an embodiment of the invention may be implemented. The computing system environment 100, as illustrated, is an example of a suitable computing environment; however it is appreciated that other environments, systems, and devices may be used to implement various embodiments of the invention as described in more detail below.

Embodiments of the invention are operational with numerous general-purpose or special purpose computing system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

Embodiments of the invention may be described in the general context of computer-executable instructions, such as program modules being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed computing environment, program modules may be located in both local and remote computer storage media including memory storage devices. Additionally, the entity that may implement, or otherwise provide the ability to implement, elements of embodiments of the invention may be referred to herein as an “administrator.”

With reference to FIG. 1, an exemplary system for implementing an embodiment of the invention includes a computing device, such as computing device 100. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 ma have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program nodules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according, to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded, to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

Referring now to FIG. 2, an embodiment of the present invention may take the form, and/or may be implemented using one or more elements, of an exemplary computer network system 200. The system 200 includes an electronic client device 210, such as a server, personal computer or workstation, tablet or smart phone that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

The client device 210 and the server 230 may include all or fewer than all of the features associated with the device 100 illustrated in and discussed with reference to FIG. 1. The client device 210 includes or is otherwise coupled, via wired or wireless connection, to a computer screen or display 250. The client device 210 may be used for various purposes such as network- and local-computing processes.

The client device 210 is linked via the network 220 to server 230 so that computer programs, such as, for example, a browser, running on the client device 210 can cooperate in two-way communication with server 230. The server 230 may be coupled to database 240 to retrieve information therefrom and to store information thereto. Database 240 may have stored therein data (not shown), such as, for example, program modules that can be used by the server 230 and/or client device 210 to enable performance of various aspects of embodiments of the invention. Additionally, the server 230 may be coupled to the computer system 260 in a manner allowing the server to delegate certain processing functions to the computer system. In an embodiment, the client device 210 may bypass network 220 and communicate directly with computer system 260.

In an embodiment, the client device 210 is a server hosting a website 270 on which a user of the client device wishes analytics to be performed by elements of an embodiment executed by one or more of server 230 and computer system 260.

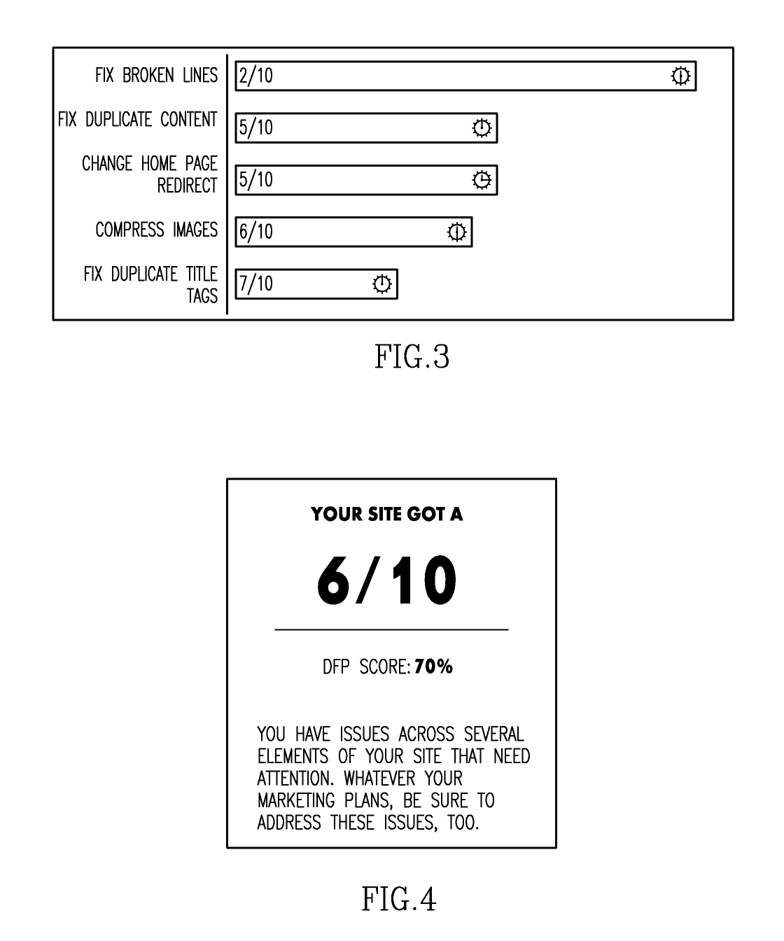

An embodiment, or elements thereof, of the invention may be referred to herein by the term “RainGage.” FIGS. 3 and 4 are functional block diagrams illustrating at least one embodiment of the invention that may be stored on and/or executed by one or more of server 230 and computer system 260 to perform analytics described herein on website 270.

There are three process elements that ultimately matter to marketers to help determine if their digital plan is working, ROI is appropriate and revenue is being generated.
1. Attribution: Which metrics (measurable things) contribute to your KPIs?
2. Correlation: What “figures” into the attribution?
3. Causation: Which metric is influencing KPIs, and by how much?

An embodiment may perform the following functions

1. Collect performance data across channels, sources and media.

2. Compare performance to key performance indicators (KPIs) and overall performance for KPIs.

3. Generate correlation using Pearson correlation for each channel, source and media over time, and across individual creative.

4. Calculate the mean correlation across each channel, source, media and creative. This mean is the ‘distance from perfect.’

5. Calculate confidence against a predetermined alpha of 95%, for example, for each mean.

6. Find cases that call outside the range generated by the confidence and distance from perfect.

7. Determine, via algorithm, the strategy indicated by each outlier.

An embodiment includes a process and method for diagnosing issues, challenges and opportunities for web site marketers; offering recommendations for solving said issue(s) to help take advantage of identified opportunities; and, finally, providing predictive reports/analysis with potential positive results (more traffic, more revenue, more . . . ).

Additionally, there are several internally developed solutions for capturing “inbound” information and data (i.e.—proprietary crawler, grammar level analysis, etc.) that, combined with open-source solutions (i.e.—Google® Analytics, large social platforms, etc.), provide crucial data for understanding the problem.

Furthermore, once data is compiled, an embodiment has the ability to discern correlations, diagnostics and assign specific scores vs. “perfect” or “ideal”.

An embodiment may connect business performance to sources and channels that don't show direct attribution to those sources or channels, and use a relative score to prioritize site changes, channel refinements and steps to align a marketing campaign with best practices. Additionally, an embodiment may move beyond ‘last click’ attribution to analysis that observes behavior by audience and ties behavior to results.

An embodiment may render results in a unique report that shows ‘distance from perfect’ for each channel, tactic or medium and prioritizes based on this distance from perfect.

An embodiment may provide CMO's. VP's and Director-of-Marketing types invaluable information and recommendations to move their web/mobile presence closer to “perfect” or “ideal”, which directly and positively impacts their KPI's (revenue, traffic, engagement, etc.).

An embodiment may provide marketers with statistical support for strategic decision-making based on a single, relative ‘distance from perfect’ scale.

An embodiment can generate valuable information for marketers regarding their digital (on-site) properties, Reports may focus on:
Channel Performance & Prescriptions: (i.e.—organic traffic, Paid traffic, social engagement, e-mail).
Content Performance & Prescriptions: (i.e.—conversions, bounce rate, time on page, FB Likes).
Site Quality & Prescriptions: (i.e.—SEO stuff . . . links, meta tags, response codes).

An embodiment may employ Pearson correlation and mean to determine a distance from perfect. This may be, a single score and scale applied across all media, channels and tactics, for easiest interpretation by users.

An embodiment may use correlation data to determine level of confidence, then use that to set range for determination of outliers versus campaign and business KPIs.

An embodiment may collect historical data using a web crawler, content inventory tool, social media APIs and offline data sources simultaneously for correlation across multiple channels and media.

An embodiment may employ algorithmic determination of cause/effect relationships between outliers and metrics.

An embodiment may employ unique data visualization to make distance from perfect scoring easy to interpret, such as in the case of the following exemplary diagram:

An embodiment may include the following features:
Assist marketing executives to move closer to “perfect” which included by performance and revenue from their digital properties.
Analysis tool in support of marketing planners
Basic ‘dashboard’ for high-level marketing decision makers
Automated ‘next actions’ marketing report
Correlated performance by channel reporting
Correlated performance by creative reporting

RainGage™ Deployment: How-to

Customer deployment

If you're a new customer and just signed up for RainGage reporting: You must
1. Provide your web site address
2. Provide social media accounts information
3. Select a crawl type and pricing level
4. Approve your first RainGage site crawl and data collection

With this information, RainGage can provide general strategic and tactical guidance regarding infrastructure, content and channels.

We recommend
1. Providing access to your web site analytics data
2. Providing access to your Google Webmaster Tools account
3. Selecting macro- and micro-conversion goals

With this information, RainGage can also provide:
Correlation-based prescriptive recommendations
Specific recommendations and guidance based on page and site conversions
Page performance evaluation

In either case, RainGage can provide valuable insight.

What happens next. Once you provide the above information, RainGage will:
1. Perform a crawl of your site, to the maximum number of pages permitted by your RainGage package
2. If possible, collect analytics and webmaster tools data
3. If possible, collect social media data
4. Assess site infrastructure needs
5. Assess site analytics gaps
6. Assess site content needs
7. Evaluate all paid, earned and owned channels based on 1-6
8. Deliver a high-level recommendations report
9. Deliver a detailed spreadsheet with supporting data

You'll receive notification about each report via e-mail. You can also log in to RainGage to get complete information.

How we generate your report

RainGage assesses your site like this:

1. The Data Collection Engine captures information about your site. It uses a web crawler to ‘index’ your website and find onsite problems. Then it uses a variety of third-party tools to collect information regarding social media performance, site performance, content virality and other metrics.

2. The Analysis Engine pulls the collected data and ranks opportunities based on each element in the marketing stack:

It determines the biggest opportunities for improvement, starting with the bottom of the stack (infrastructure) and working its way up. If it encounters serious issues lower in the stack, the Analysis Engine may stop there. The reason: Serious problems with your web site lower in the stack may reduce the benefit of improvements higher up.

For example, if your site has serious infrastructure problems, such as pages that load in 10+ seconds, it doesn't make sense to spend a great deal of time improving paid search just yet. The infrastructure issues will drive away far more visitors than improved page search can attract.

RainGage makes this determination automatically. It does not mean you should shut down existing campaigns. It simply means you should locus on basic issues first.

3. The Recommendations Engine use the analysis to generate your report. The report will include strategic recommendations—what to focus on first, etc. Click on strategic recommendations, and you'll see more detailed data. For example, in the chart below, clicking ‘Fix Broken Links’ will show a list of broken links. This lets you quickly find and fix the links:

The numeric score at the start of each bar is on a 0-10 scale. The closer to 10, the better you're doing for that item. You will rarely see an 8/10 score in the Top Priorities area. If you've got an 8/10, it's probably not a top priority!

The stopwatch at the end of each bar tells you the effort involved with each task. The more full the stopwatch, the more time we believe the task will take.

The length of the bar tells you the severity of the problem.

4. Recommendations are graded on a curve. The score is a relative one based on other site issues. So we're always measuring and determining priorities based on your site's current performance.

What about the grade and DFP score?

The grade is an overall rating on a scale from 0-10. It's RainGage's high-level impression of your site. The DFP score is your Distance From Perfect. This is an absolute score based on the theoretical ‘perfect’ web site. Anything above 50% is solid. Anything above 80% is fantastic. Anything above 90% is the stuff of legends.

1. A system according to principles described herein.

2. A method comprising the step of analyzing a website and generating a performance grade of said website.
